(19) United States
(12) Patent Application Publication
(10) Pub. No.: US 2009/0101447 A1
(43) Pub. Date: Apr. 23, 2009

(54) Forklift Height Indicator

(76) Inventors: Terry Durham, Summers, AR (US); Loren Lawrence, Rogers, AR (US)

Correspondence Address: Fay Kaplun & Marcin, LLP/ Motorola, 150 Broadway Suite 702, New York, NY, 10038, US

(21) Appl. No.: 12/123,692

(22) Filed: May 20, 2008

Related U.S. Application Data
(60) Provisional application No. 60/982,019, filed on Oct. 23, 2007.

(51) Int. Cl. B66F 9/08

(52) U.S. Cl. 187/238

(57) ABSTRACT

A forklift may include (a) a mast; (b) forks which are substantially perpendicular to the mast; (c) a load backrest adjacent to the mast, the load backrest and the forks are coupled and moveable along a longitudinal direction of the mast; and (d) a height measuring component determining a location of the forks relative to the mast.

### PRIORITY CLAIM

This application claims the priority to the U.S. Provisional Application Ser. No. 60/982,019, entitled “Forklift Height Indicator Using RFID,” filed Oct. 23, 2007. The specification of the above-identified application is incorporated herewith by reference.

### FIELD OF THE INVENTION

The present invention relates generally to a forklift height indicator. Specifically, the height of forks that are raised and lowered may be determined using sensing components.

### BACKGROUND

A forklift may be used in a variety of environments. The forklift may assist users in moving heavy loads and placing the loads in different locations including areas that are elevated. The elevations of the areas may be different, depending on a variety of factors such as a quality of supports. In certain environments, the loads are stacked on top of one another on a common rack. Furthermore, safety policies may be instituted regarding placement of loads such as when the loads are stacked, the forklift is idle, etc.

### SUMMARY OF THE INVENTION

The present invention relates to a forklift and, in particular, to a forklift height indicator. The forklift may include (a) a mast; (b) forks which are substantially perpendicular to the mast; (c) a load backrest adjacent to the mast, the load backrest and the forks are coupled and moveable along a longitudinal direction of the mast; and (d) a height measuring component determining a location of the forks relative to the mast.

### DESCRIPTION OF THE DRAWINGS

FIG. 1 shows an exemplary forklift according to a first and a second exemplary embodiment of the present invention.

FIG. 2 shows an exemplary forklift according to a third exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a forklift equipped with sensing components to indicate a height of forks. According to the exemplary embodiments of the present invention, the sensing components may include at least one of a radio frequency identification (RFID) sensor, a barcode reader, and a sonic sensor. The forklift, the forks, the RFID sensor, the barcode reader, and the sonic sensor will be discussed in more detail below. Those skilled in the art will understand that other types of sensing components may also be used and may be substituted for the described sensing components.

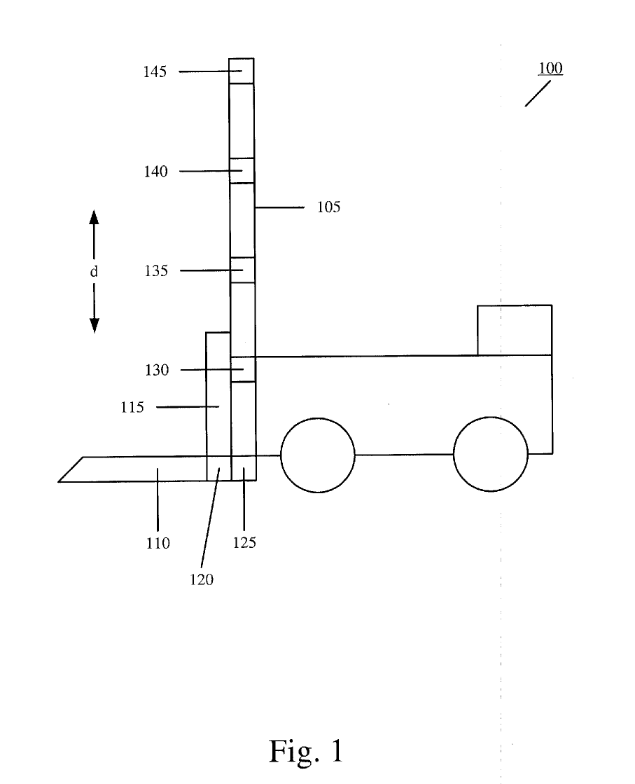

FIG. 1 shows an exemplary forklift 100 according to a first and a second exemplary embodiment of the present invention. The forklift 100 may be used in any environment in which loads, in particular heavy loads, are transported. The forklift 100 offers movement of the loads in all three dimensions. The forklift 100 may include components such as a mast 105, forks 110, and a load backrest (LBR) 115. It should be noted that other components may be included such as a seat in which a user is disposed, controls to operate the forklift 100, wheels to move the forklift 100, an engine, etc.

The mast 105 may be a vertical assembly disposed on a front end of the forklift 100. The mast 105 may be responsible for moving the loads in a vertical direction. Furthermore, the mast 105 may enable the loads to be tilted. The mast 105 may be, for example, hydraulically operated using one or more cylinders and interlocking rails for lifting/lowering operations and lateral stability. In another example, the mast 105 may be operated with a hydraulic motor providing motive power.

The forks 110 may be two or more flat metal plates extending in a substantially perpendicular direction away from the mast 105. The forks 110 may be attached to a carriage. The carriage may be coupled to the mast 105 using, for example, chains or direct attachment to the hydraulic cylinder. The carriage may be the component that is moved along the mast in a direction d. The forks 110 may be coupled to the carriage using, for example, hooks/latches or a shaft mount. Each front end of the forks 110 may be tapered for ease of insertion into the load. The forks 110 may be inserted into or underneath the load, usually on a pallet or skid, so that the load may be picked up.

The LBR 115 may be included in the forklift 100 to prevent the load from shifting backward, especially when the load is raised to a height greater than the mast 105. The LBR 115 may be disposed in a substantially similar location as the carriage. That is, a bottom edge of the LBR 115 may be substantially similar to a bottom edge of the carriage which coincides with the coupling area of the forks 110.

In addition to the above described components, according to the exemplary embodiments of the present invention, the forklift 100 may further include a reader 120 and a plurality of tags 125-145. As will be explained in further detail below, according to the exemplary embodiments of the present invention, the first exemplary embodiment includes the reader 120 being an RFID reader and the tags 125-145 being a plurality of RFID tags. The second exemplary embodiment includes the reader 120 being a barcode reader and the tags 125-145 being a plurality of barcodes.

According to the first exemplary embodiment of the present invention, the RFID reader 120 may be a conventional RFID reader that includes a transceiver and antenna to receive RF data, in particular from the RFID tags 125-145. The RFID reader may be disposed on one of the LBR 115, the carriage, the forks 110, etc. As illustrated, the RFID reader may be disposed on the LBR 115 near a proximal end of the forks 110. The RFID tags 125-245 may be conventional RFID tags that include an integrated circuit and antenna. For example, the RFID tags may be active RFID tags, passive RFID tags, or semi-passive RFID tags. Each RFID 125-145 tag may be disposed at predetermined locations along the mast 105. As illustrated, the tag 125 may be disposed at a bottom edge of the mast 105; the tag 130 may be disposed at a quarter height of the mast 105; the tag 135 may be disposed at a half height of the mast 105; the tag 140 may be disposed at a three quarter height of the mast 105; and the tag 145 may be disposed at a top edge of the mast 105.

The disposition of the RFID reader 120 and the RFID tags 125-145 enable a determination of height to be made directly related to the forks 110 and indirectly related to the load placed in or on the forks 110. As the forks 110, the LBR 115, the carriage, and the load are moved along the mast 105, the RFID reader 120 may receive RF data from the RFID tags 125-145. Depending on the location at which the forks 110, the LBR 115, the carriage, and the load are disposed on the mast 105, a height determination may be ascertained. For example, if a particular RFID tag has been or is being read, the tag may indicate the height.

Each of the RFID tags 125-145 may be encoded with data such that the RF data received by the RFID reader 120 indicates the height. In a first exemplary embodiment, the RFID tags 125-145 may transmit the corresponding height to the RFID reader 120. The height may then be shown on a display of the forklift 100 to indicate to an operator of the forklift 100 the height at which the forks 110 are disposed. In a second exemplary embodiment, the RFID tags 125-145 may transmit an identity to the RFID reader 120. The identity of each of the tags 125-145 may be included in a database indicating a height. Thus, when the RFID reader 120 receives the identity data from one the RFID tags 125-145, the database may be referenced so that a corresponding height may be indicated. The height may be shown on the display of the forklift 100.

In a substantially similar manner as the RFID reader 120, according to the second exemplary embodiment of the present invention, the reader 120 may be a barcode reader. The barcode reader 120 may be a conventional barcode reader that includes a scanning engine (e.g., imager based, laser based, etc.) to read the barcodes. The barcode reader 120 may also be disposed on a substantially similar position as the RFID reader such as the LBR 115, the carriage, the forks 110, etc. The barcodes 125-145 may be conventional barcodes such as one-dimensional barcodes, two-dimensional barcodes, color barcodes, etc. Each barcode 125-145 may be disposed at predetermined locations along the mast 105 in a substantially similar manner as the RFID tags. Also in a substantially similar manner, the barcodes 125-145 may be encoded with data indicating the height. Thus, when the barcode reader 120 scans one of the barcodes 125-145, the data encoded therein may be decoded indicating the corresponding height or may be decoded indicating an identity of the barcode that is referenced to a database that indicates the height.

It should be noted that the database that indicates the height may be stored in a variety of locations. In a first example, an on-board computer of the forklift 100 may include the database. The on-board computer may include a memory that stores the database. In another example, the forklift 100 may include a transceiver that associates an on-board computer of the forklift 100 with a network. A storage unit of network may store the database. Thus, a height determination of the forks 110 may be transmitted via the transceiver to a network component that accesses the database that indicates the height.

The disposition of the barcode reader 120 and the barcodes 125-145 also enable a determination of height to be made directly related to the forks 110 and indirectly related to the load placed in or on the forks 110. As the forks 110, the LBR 115, the carriage, and the load are moved along the mast 105, the barcode reader 120 may scan the barcodes 125-145. Depending on the location at which the forks 110, the LBR 115, the carriage, and the load are disposed on the mast 105, a height determination may be ascertained.

It should be noted that the number of tags 125-145 being five is only exemplary. According to the exemplary embodiments of the present invention, the forklift 100 may include, at a minimum, two sensing tags. The forklift 100 may also include additional sensing tags if a more precise determination of height is desired or required.

It should also be noted that the reader 120 is not limited to reading the tags 125-145. The sensor 120 may also be configured to determine a presence of the load (e.g., by reading a tag similar to the tags 125-145 or by incorporating a different type of sensor such as a piezoelectric pressure sensor, an optical distance sensor, etc.), determine movement of the forklift 100 (e.g., by incorporating a MEMS sensor), determine a direction in which the forklift 100 is moving, determine what the load is, etc. The additional data ascertained by the sensor 120 may be incorporated with the height data read from the sensing tags 125-145.

It should further be noted that the tags 125-145 being RFID tags or barcodes is only exemplary. For example, in another exemplary embodiment, the tags 125-145 may be optical character recognition (OCR) strings. Thus, a respective reader 120 may be used to translate images of handwritten text, typewritten or printed text, etc. into machine readable text.

Furthermore, it is noted that the reader 120 and the tags 125-145 may be permanently or removably disposed. The reader 120 may be permanently attached to one of the locations described above. The reader 120 may also be removably attached to one of those locations. For example, a port may be disposed at the location (e.g., the proximal end of forks 110, the carriage, the LBR 115, etc.) to receive the reader 120. The reader 120 may subsequently be removed when a height determination is not necessary. In another example, the reader 120 may be equipped with locking mechanisms so that when unlocked, the reader 120 may be freely moved. The locking mechanism may then be locked to hold the reader 120. The tags 125-145 may also be permanently attached or removably attached in a substantially similar way as the reader 120. Furthermore, the tags 125-145 may be configured so that they be moved along the mast 105. The tags 125-145 may be equipped with a locking mechanism that clips onto the mast 105. The clips may be configured to enable the tags 125-145 to remain stationary at a point on the mast 105 but may also enable the tags 125-145 to be movable along the mast 105 by a sliding motion. Thus, the tags 125-145 may be used to determine any height at which they are disposed on the mast 105 and are not limited to the height corresponding to the predetermined locations along the mast 105. When the tags 125-145 are movable, the tags 125-145 may be encoded with the identity data described above. Thus, when the reader 120 receives/scans the identity data, the database (that is updated when the tags 125-145 are moved) may indicate the corresponding height.

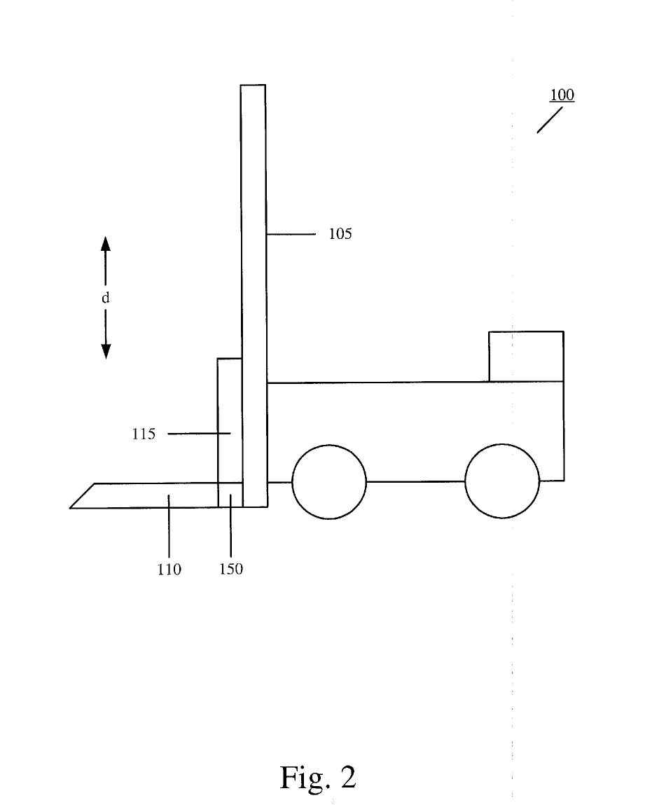

FIG. 2 shows an exemplary forklift 100 according to a third exemplary embodiment of the present invention. The forklift 100 of the second exemplary embodiment of the present invention may be substantially similar to the forklift 100 of the first exemplary embodiment. That is, the forklift 100 may include components such as the mast 105, the forks 110, the LBR 115, the seat, the controls, the wheels, the engine, etc.

According to the second exemplary embodiment of the present invention, the forklift 100 may further include a sonic sensor 150. The sonic sensor 150 may be a conventional sonic sensor (e.g., ultra sonic sensor). The sonic sensor 150 may include a transmitter that transmits a sound and a sensor that receives an echo of the sound. A travel time of the sound may be used with a frequency of the sound to determine a distance. The sonic sensor 150 may be disposed on a bottom side of the forks 110. Specifically, the sonic sensor 150 may be oriented to face a floor in which the forklift 100 is disposed. Accordingly, when the sonic sensor 150 transmits the sound, the echo is produced upon reflecting off the floor. Thus, the distance that is determined corresponds to the height of the forks 110 and the load.

The sonic sensor 150 may specifically be disposed at proximal ends of the forks 110. As discussed above, the mast 105 may enable loads to be tilted. Consequently, distal ends of the forks 110 may be raised so that a height of the distal ends of the forks 110 is greater than proximal ends of the forks 110 where the forks 110 extend from the mast 105. The sonic sensor 150 may determine the height of the proximal ends of the forks 110 and may also extrapolate the height of the distal ends of the forks 110 when an angle of tilting is available. As will be discussed below, the determination of both heights may be useful to the operator of the forklift 100.

It should be noted that a further sonic sensor may be disposed on the distal ends of the forks 110. The further sonic sensor may be used to determine the height of the distal ends of the forks 110. Thus, a further determination is not required when the sonic sensor 150 determines the height of the proximal ends of the forks 110. In addition, the further sonic sensor disposed at the distal ends of the forks 110 may also be used to determine the height of the proximal ends to, for example, serve as a check to the height determined from the sonic sensor 150 disposed at the proximal ends. The further sonic sensor may also be used to determine a distance from the distal ends to an object disposed in front of the forklift 100. For example, a load may be placed onto a shelf. The forklift 100 may determine the distance to the shelf via the further sonic sensor so that the operator of the forklift 100 may move the load accordingly (e.g., available space to move forward, lack of space so need to move backward, etc.).

The height determination may be used for a variety of purposes. In a first example, when using RFID to place RFID tagged loads with or without pallets into RFID tagged warehouse slots, knowing the height of the forks allows for the more accurate associations of the load/pallet to the location. In particular, with multiple stacked loads, the accurate associations may be pertinent prior to, for example, placing a double stacked load/pallet on the warehouse rack. For example, a height of a load may further indicate a third dimension to a location of the load. The load may be in an elevated slot in the warehouse. Additional loads to be placed on top of, next to, etc. the load may be placed accordingly.

In a second example, knowing the height of the forks 110 on the forklift 100 may be used to ensure safety policies (e.g., company based, industry based, etc.) are being followed. For example, one safety policy may relate to using the forklift 100 at certain speeds. The policy may indicate that at high speeds, the forks 110 are not to exceed a certain height. Thus, if the forks 110 are determined to be disposed beyond an acceptable height, the operator of the forklift 100 may be alerted (e.g., shown on a display, playing an audio component, etc.). The operator may then slow down, move the forks 110 to an acceptable height, etc. In another example, one safety policy may relate to the forklift 100 being unattended. The policy may indicate that when the forklift 100 is unattended, the forks 110 are not to exceed a certain height. Thus, if the forklift 100 is powered down and a determination is made that the forks 110 are at an unacceptable height, the operator may be alerted (e.g., shown on a display, playing an audio component, etc.) of this condition so that the forks 110 are moved to an acceptable height. As discussed above, the forklift 100 may further be configured with a transceiver that transmits data relating to the height of the forks 110 to a network component. The network component may determine if the forks 110 are at an acceptable height for various conditions (e.g., moving forklifts, unattended forklifts, etc.). If the forks 110 are not an the acceptable height, a command signal may be transmitted to the forklift 100 via the transceiver to alert the operator. In another example, an administrator of the network may be indicated that a particular forklift 100 has forks 110 in an unacceptable height. The operator of the forklift 100 may have a communication device on his/her person or part of the forklift 100. The administrator may contact the operator indicating the unacceptable height.

It should be noted that the exemplary embodiments using a single reader or a sonic sensor is only exemplary. The exemplary embodiments of the present invention may incorporate up to both types of readers and the sonic sensor. For example, in the first exemplary embodiment where the reader 120 is the RFID reader, the barcode reader may also be disposed on the forklift. The barcode reader may serve to provide additional data (e.g., to verify the RFID readings), different data (e.g., a different height determination), etc. Furthermore, the sonic sensor may be added to provide the various features that the sonic sensor is capable of performing.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A forklift, comprising:
a mast;
forks being substantially perpendicular to the mast;
a load backrest adjacent to the mast, the load backrest and the forks being coupled and moveable along a longitudinal direction of the mast; and
a height measuring component determining a location of the forks relative to the mast.

2. The forklift of claim 1, wherein the height measuring component is a radio frequency identification (RFID) reader.

3. The forklift of claim 2, further comprising:
a plurality of RFID tags disposed in predetermined locations along the longitudinal direction of the mast.

4. The forklift of claim 3, wherein, when the RFID reader receives RF data from one of the plurality of RFID tags, the location of the forks is determined.

5. The forklift of claim 1, wherein the height measuring component is a barcode reader.

6. The forklift of claim 5, wherein the barcode reader is oriented to scan a plurality of barcodes disposed in predetermined locations along the longitudinal direction of the mast.

7. The forklift of claim 6, wherein, when the barcode reader scans one of the plurality of barcodes, the location of the forks is determined.

8. The forklift of claim 1, wherein the height measuring component is a sonic sensor disposed on a bottom side of the forks.

9. The forklift of claim 3, wherein the plurality of RFID tags is disposed one of permanently and removably.

10. The forklift of claim 9, wherein, when the plurality of RFID tags is disposed permanently, each of the RFID tags is encoded with data indicating the location and, when the plurality of RFID tags is disposed removably, each of the RFID tags is encoded with data indicating a respective identity, the identity indicating the location.

11. The forklift of claim 6, wherein the plurality of barcodes is disposed one of permanently and removably.

12. The forklift of claim 11, wherein, when the plurality of barcodes is disposed permanently, each of the barcodes is encoded with data indicating the location and, when the plurality of barcodes is disposed removably, each of the barcodes is encoded with data indicating a respective identity, the identity indicating the location.

13. An arrangement, comprising:
a reader adapted to be disposed on one of forks and a load backrest of a forklift, the one of the forks and the load backrest moveable along a longitudinal direction of a mast of the forklift; and
a plurality of tags adapted to be disposed in predetermined locations along the longitudinal direction of the mast,
wherein, when the reader reads one of the plurality of tags, a location of the forks relative to the mast is determined.

14. The arrangement of claim 13, wherein the reader is an RFID reader and the plurality of tags is a plurality of RFID tags.

15. The arrangement of claim 13, wherein the reader is a barcode reader and the plurality of tags is a plurality of barcodes.

16. An arrangement, comprising:
a transmitter disposed on a bottom side of forks of a forklift, the forks coupled to a load backrest, the coupling being movable along a longitudinal direction of a mast that is perpendicular to a floor, the transmitter transmitting a sound toward the floor; and
a sensor disposed on the bottom side of the forks of the forklift, the sensor receiving an echo of the sound to determine a height of the forks.

17. The arrangement of claim 16, wherein the transmitter is disposed at a proximal end of the forks.

18. The arrangement of claim 16, wherein a time for the sound to be transmitted, a time for the echo to be received, and a frequency of the sound is used for the determining of the height.

19. The arrangement of claim 16, further comprising:
a further sensor disposed on a distal end of the forks of the forklift, the sensor receiving an echo of a sound transmitted to an object to determine a distance of the forks to the object.

20. A forklift, comprising:
a mast;
forks being substantially perpendicular to the mast;
a load backrest adjacent to the mast, the load backrest and the forks being coupled and moveable along a longitudinal direction of the mast; and
a height measuring means for determining a location of the forks relative to the mast.
